(19) United States
(12) Patent Application Publication
(10) Pub. No.: US 2024/0420065 A1
(43) Pub. Date: Dec. 19, 2024

(54) DETERMINING INFRASTRUCTURE LOCATIONS USING GEOGRAPHIC TILING

(71) Applicant: Othersphere Systems Inc., Vancouver (CA)

(72) Inventors: Robert Jonathan Murphy, Victoria (CA); William Christopher Sonnex, Victoria (CA)

(21) Appl. No.: 18/658,186

(22) Filed: May 8, 2024

Related U.S. Application Data
(60) Provisional application No. 63/521,811, filed on Jun. 19, 2023.

(51) Int. Cl. G06Q 10/067

(52) U.S. Cl. CPC G06Q 10/067

(57) ABSTRACT

A system for determining infrastructure locations using geographic tiling comprises an interface and a processor. The interface is configured to receive a user request. The processor is configured to determine a set of source geographic tiles based at least in part on the user request, wherein one or more source characteristics are associated with a source geographic tile of the set of source geographic tiles; determine a list of consumption geographic tiles, wherein one or more consumption parameters are associated with a consumption geographic tile of the list of consumption geographic tiles; generate a user display based at least in part on the one or more source characteristics and on the one or more consumption parameters; and provide the user display to a user associated with the user request.

### CROSS REFERENCE TO OTHER APPLICATIONS

This application claims priority to U.S. Provisional Patent Application No. 63/521,811 entitled DETERMINING INFRASTRUCTURE LOCATIONS USING GEOGRAPHIC TILING filed Jun. 19, 2023 which is incorporated herein by reference for all purposes.

### BACKGROUND OF THE INVENTION

Building infrastructure is a complex, expensive proposition with potentially significant human and environmental impacts that extend beyond the economic objectives of the project. A key determinant of infrastructure performance is location. For example, the position of a production facility influences costs for building, costs for operating, greenhouse gas emissions of construction and operation, local factors that may constrain or enable a project, and the number of end users that can be served from that location. As a result, the decision of where to locate infrastructure becomes a highly complex, multi-criteria analysis. Furthermore, due to this analytical complexity, it is very difficult to assess a large number of potential locations in a systematic manner, to determine the ideal location to site infrastructure relative to all alternatives.

### BRIEF DESCRIPTION OF THE DRAWINGS

Various embodiments of the invention are disclosed in the following detailed description and the accompanying drawings.

FIG. 1 is a block diagram illustrating an embodiment of a system for determining infrastructure locations.

FIG. 2A is a block diagram illustrating an embodiment of a system for determining infrastructure locations.

FIG. 2B is a flow diagram illustrating an embodiment of a process for ingesting data.

FIG. 2C is a flow diagram illustrating an embodiment of a process for a system for determining infrastructure locations.

FIG. 2D is a flow diagram illustrating an embodiment of a process for a system for determining infrastructure locations.

FIG. 2E is a diagram illustrating an embodiment of determining cost associated with a production tile.

FIG. 3 is a diagram illustrating an embodiment of tiles associated with determining infrastructure locations.

FIG. 4 is a diagram illustrating an embodiment of a user interface for a system determining infrastructure locations.

FIG. 5 is a diagram illustrating an embodiment of a user interface for a system determining infrastructure locations.

FIG. 6 is a diagram illustrating an embodiment of a user interface for a system determining infrastructure locations.

FIG. 7 is a diagram illustrating an embodiment of a user interface for a system determining infrastructure locations.

FIG. 8 is a diagram illustrating an embodiment of a user interface for a system determining infrastructure locations.

FIG. 9 is a diagram illustrating an embodiment of a user interface for a system determining infrastructure locations.

FIG. 10 is a diagram illustrating an embodiment of a user interface for a system determining infrastructure locations.

FIG. 11 is a diagram illustrating an embodiment of a user interface for a system determining infrastructure locations.

FIG. 12 is a diagram illustrating an embodiment of a user interface for a system determining infrastructure locations.

FIG. 13 is a diagram illustrating an embodiment of a user interface for a system determining infrastructure locations.

FIG. 14 is a diagram illustrating an embodiment of a user interface for a system determining infrastructure locations.

FIG. 15 is a diagram illustrating an embodiment of a user interface for a system determining infrastructure locations.

FIG. 16 is a diagram illustrating an embodiment of a user interface for a system determining infrastructure locations.

FIG. 17 is a diagram illustrating an embodiment of a user interface for a system determining infrastructure locations.

FIG. 18 is a flow diagram illustrating an embodiment of a process for determining infrastructure locations.

FIG. 19 is a flow diagram illustrating an embodiment of a process for receiving a user request.

FIG. 20 is a flow diagram illustrating an embodiment of a process for generating a display.

FIG. 21 is a flow diagram illustrating an embodiment of a process for generating a display.

FIGS. 22A and 22B are a flow diagram illustrating an embodiment of a process for determining whether a new user display is needed.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for determining infrastructure locations using geographic tiling is disclosed. The system comprises an interface and a processor. The interface is configured to receive a user request. The processor is configured to determine a set of source geographic tiles based at least in part on the user request, wherein one or more source characteristics are associated with a source geographic tile of the set of source geographic tiles; determine a list of consumption geographic tiles, wherein one or more consumption parameters are associated with a consumption geographic tile of the list of consumption geographic tiles; generate a user display based at least in part on the one or more source characteristics and on the one or more consumption parameters; and provide the user display to a user associated with the user request.

In some embodiments, the system analyzes locations by exploring potential sites of source production facilities and considering consumption sites and the transportation between them. In some embodiments, assessing production at each tile is the first step in the analysis, where hundreds of different project production configurations are analyzed across millions of individual tiles. These configurations yield the expected production costs, expected greenhouse gas emissions, and expected viability of the of producing in that tile based on local human and environmental factors (for example, population density or presence of protected environmental areas). In some embodiments, the potential users of the project are determined, based on their immediate local proximity, or ability to connect over longer distances through existing or planned transportation infrastructure. This transport analysis relies on transport tiles, which have been created when transport infrastructure such as road, pipelines, power lines, rail lines, data transmission lines, or maritime shipping lanes exist within a tile area. In some embodiments, these transport tiles are assigned the key characteristics of transport infrastructure that exist within the tile area, which are used to determine factors such as the estimated transport costs and emissions. In some embodiments, the location of the production tiles and subsequent consideration of relevant transport tiles, determines the end user demand tiles that can be served by each individual project permutation. In some embodiments, the system now generates project economics and emissions estimates, based on production, transport, and specific end users. This analysis is repeated for many different project configurations at each of the millions of tiles assessed within the system, generating billions of comprehensive project permutations for consideration.

Typically, the process of running equipment sizing and operating strategy levelized cost of hydrogen (LCOH) optimizations for electrolysis plants is cumbersome and time-consuming. It takes days to weeks to get the data, with the optimization itself often taking hours. This bottleneck restricts analytical efforts to a handful of potential sites, leaving many opportunities unexplored. The result? Sub-optimal capital allocation and risk profiles, with countless missed opportunities. Transitioning from initial calculations to hourly optimizations yields cost estimates that surpass the vast majority of studies found online, but also highlights location as a significant cost driver.

In some embodiments, the disclosed system has revolutionized this process by combining the power of an underlying data platform with neural networks for dimensionality reduction and surrogate modeling. The system's global search engine now recommends pre-optimized projects in seconds, having already run an hourly optimization considering:
wholesale power market pricing
Grid upgrade capital expenditure (CAPEX) based on class 5 estimates from Siemens Energy
Grid fees associated with transmission connections;
Variable stack efficiency by load, incorporating operational ranges;
System economies of scale, as well as commercial and technical nuances between proton exchange membrane (PEM) and alkaline plants;
Hourly carbon intensity data;
Demand profiles and cost of storage;
Co-located renewables CAPEX; and
High-spatial resolution hourly solar and wind capacity factor data following an in-house development with Ian Staffel from Imperial College London.
   The disclosed delivers a bottom-up view of potential hydrogen projects, evaluating key factors such as productions costs, emissions, available off-takers, and the fit with local surroundings.

The system makes the computer better by making computation more efficient to determine a location for infrastructure. In some embodiments, the computation is made more efficient by selecting a starting point using machine learning models. The user interface can deliver recommendations for potential project and sites based on analysis of the billions of project permutations contained within the system, prioritizing display to users based on considerations such as scoring based on comprehensive project attributes (such as an Othersphere score), based on key individual metrics such as production economics or greenhouse gas emissions, or based on the preferences of the individual software user. This prioritization might be refined through manual user adjustment of the user interface, or might be determined through user engagement with a computer assistant tool which helps assess user preferences. In some embodiments, the computation is made more efficient by reducing the optimization computation for a location using a model to make calculation of the source or consumption parameters more rapid. This could be achieved by training models based on the conditions of tiles within the system, and the results of analyzing billions of potential infrastructure projects based on those tiles. In some embodiments, these models will be developed based on the characteristics that are determined to have the strongest ability to predict specific analysis outcomes, allowing predicted results to be provided more quickly within a reasonable error range. In some embodiments, this will be used to simplify computations that would be cost and/or time prohibitive to run across the entire system.

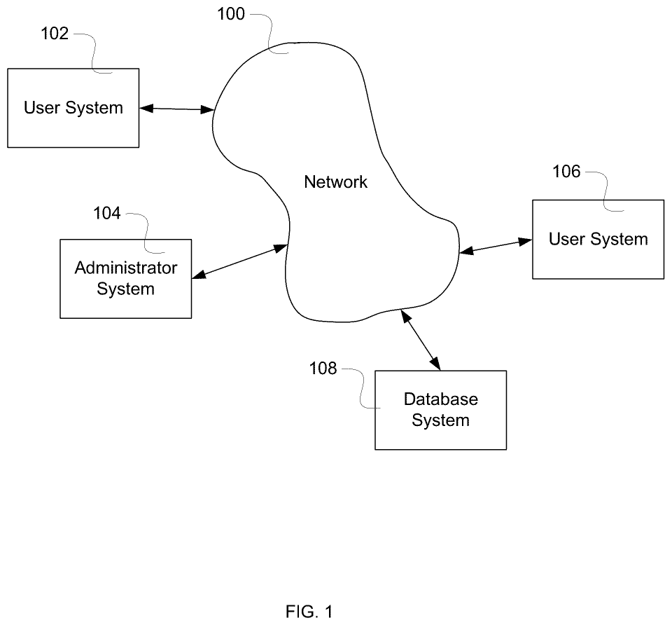

FIG. 1 is a block diagram illustrating an embodiment of a system for determining infrastructure locations. In the example shown, a user using a user system (e.g., user system 102, user system 106, etc.) interacts with database system 108 to provide information and/or requests and receive information and/or output data regarding locations. Administrator(s) uses administrator system 104 to maintain, service, oversee, and/or any other appropriate administration function database system 108.

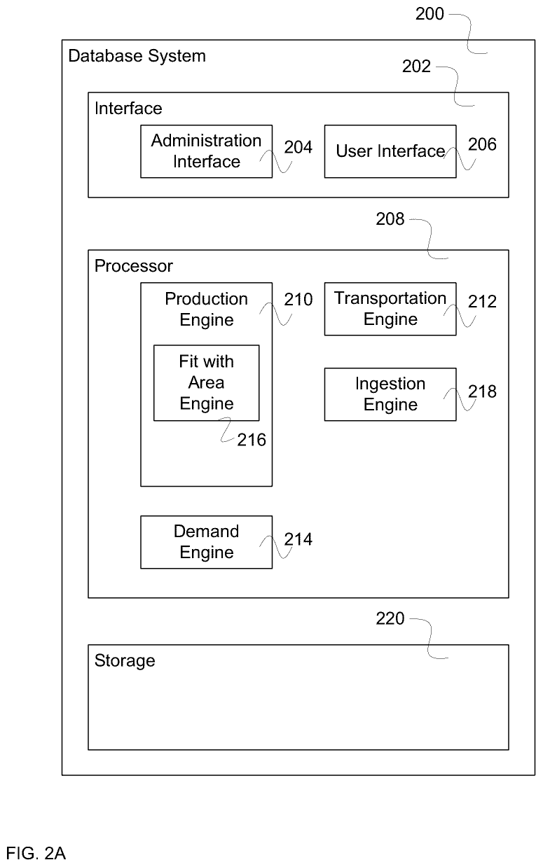

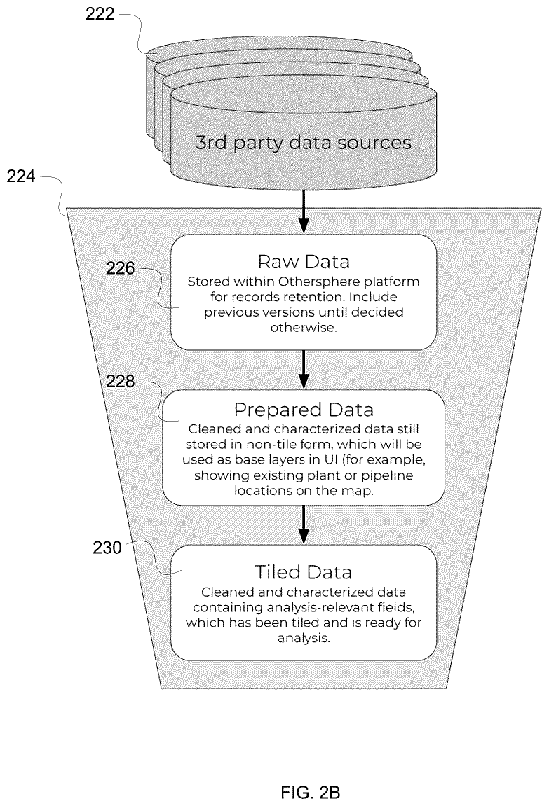

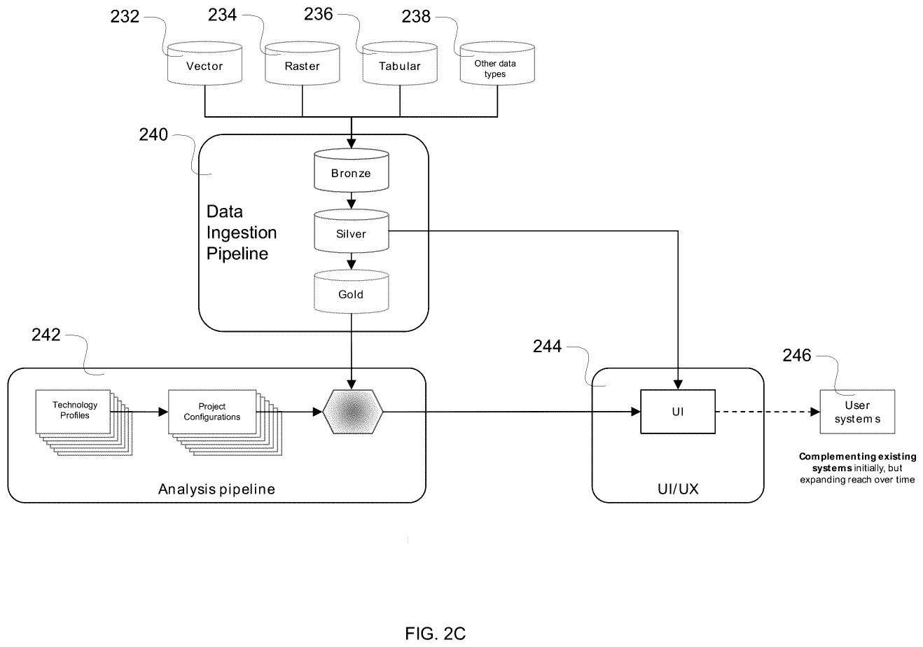

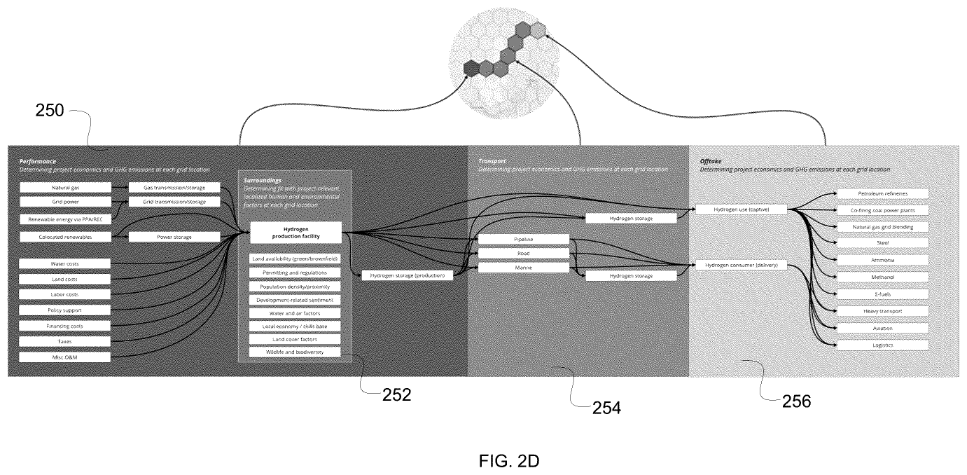

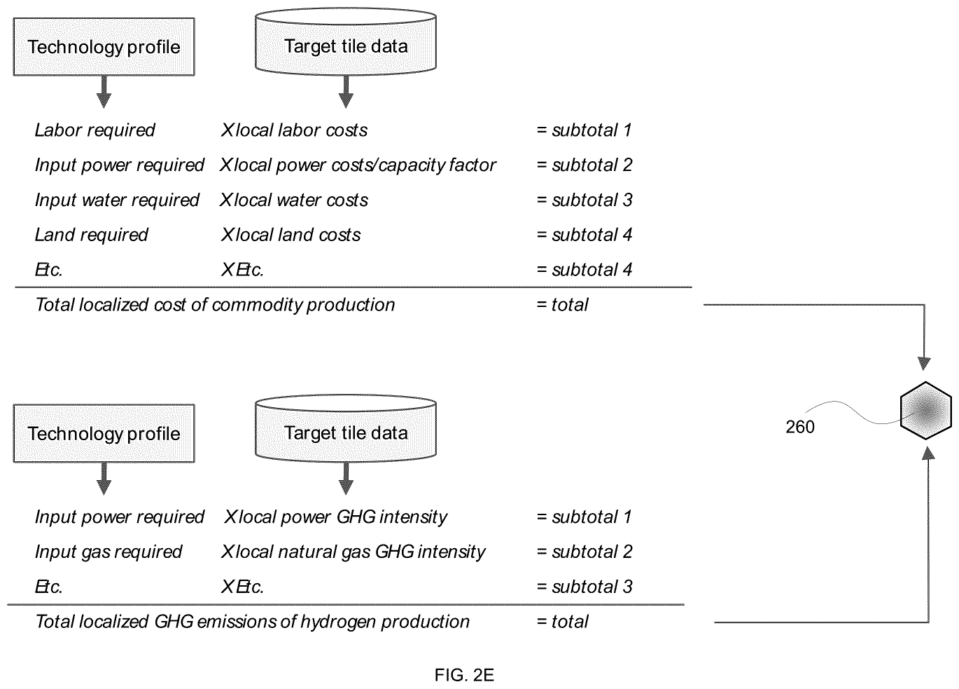

FIG. 2A is a block diagram illustrating an embodiment of a system for determining infrastructure locations. In some embodiments, database system 200 of FIG. 2 is used to implement database system 108 of FIG. 1. In the example shown, database system 200 includes interface 202, processor 208, and storage 220. Interface 202 includes administration interface 204 and user interface 206. Administration interface 204 enables an administrator to maintain and update database system 200. User interface 206 enables one or more users to interact with database system 200 including providing input data, providing configuration data, providing preference data, providing request(s), providing user interface input(s), providing commands, or any other appropriate user interaction with database system 200. Processor 208 includes production engine 210, which includes fit with area engine 216, demand engine 214, transportation engine 212, and ingestion engine 218. In some embodiments, ingestion engine 218 is separate from processor 208 and/or storage 220. Storage 220 is used for storing ingested data and/or output calculation data associated with production locations, demand locations, and transportation between production locations and demand locations.

FIG. 2B is a flow diagram illustrating an embodiment of a process for ingesting data. In some embodiments, the process of FIG. 2B is used to implement ingestion for ingestion engine 218 of FIG. 2A. In the example shown, data sources 222 information is acquired and/or received by the database system and stored. Data sources 222 will vary between 3rd party providers and/or proprietary administrator-created data, covering the range of topics that impact the economics, greenhouse gas emissions, or local fit which determine optimal location selection. Data types will include static or time series data, stored in common tabular or geospatial data formats. Process 224 outlines stages of ingesting data including raw data stage 226, prepared data stage 228, and tiled data stage 230. In some embodiments, raw data stage 226 of ingestion comprises storing the raw data along with metadata information indicating a date of ingestion so that versions are maintained. Prepared data stage 228 of ingestion comprises assessing raw data including checking for completeness and usability in location optimization analysis. Prepared data stage 228 of ingestion further comprises cleaning including removal of null or error values and normalized to internal standard of format and units and characterizing and storing in a form not associated with a tile. For example, the data indicates existing plant(s) or pipeline location(s) on a map. Tiled data stage 230 of ingestion comprises associating cleaned and characterized data with a tile, merging (if needed, where multiple data sources covering different locations are required to complete a global tile dataset), and storing the association of the data with its related tile.

FIG. 2C is a flow diagram illustrating an embodiment of a process for a system for determining infrastructure locations. In some embodiments, the process of FIG. 2C is implemented using a database system (e.g., database system 108 of FIG. 1 and/or database system 200 of FIG. 2). In the example shown, data sourcing for the system includes free/open, paid, and proprietary sources with a focus on variables of the highest consequences to an infrastructure project's success. The data sources include vector 232, raster 234, tabular 236, and other data types 238. The system includes data ingestion pipeline 240 in which first stores data in its raw form (Bronze), proceeding through cleaning and characterization (Silver), and then merged and tiled for utilization in the analysis pipeline (Gold). Analysis pipeline 242 includes technology profiles with all of the key characteristics of commodity production technologies and project configurations with the operational (e.g., power source) and commercial (e.g., depreciation method) choices associated with their deployment. The permutations of the technology profiles with different project configurations are calculated for each of the geographic tiles. The myriad of permutation results are delivered to a user interface (UI/UX 244) to reveal locations where the project will have the best absolute/relative performance. UI/UX 244 receives the permutation results and data from the ingestion pipeline and generates an intuitive experience so that the analysis results are easily digestible to a user using user system 246 with easily visualizable and accessible details and data confidence results.

FIG. 2D is a flow diagram illustrating an embodiment of a process for a system for determining infrastructure locations. In some embodiments, the process of FIG. 2D is implemented using a database system (e.g., database system 108 of FIG. 1 and/or database system 200 of FIG. 2). In the example shown, the analysis pipeline for the system for determining infrastructure locations determines project economics and green house gas (GHG) emissions at each tile location (performance 250). For example, the project economics determination considers power sources (e.g., natural gas including gas transmission/storage; grid power including grid transmission/storage; renewable energy including physical power purchase agreements and associated renewable energy certificates; collocated renewables and power storage; etc.). The project economics determination further considers other costs and factors including water costs, land costs, labor costs, policy support, financing costs, taxes, operation and maintenance costs/factors, etc.). The analysis pipeline for the system for determining infrastructure locations further determines the surroundings for the project (e.g., surroundings 252). For example, project relevant localized human and environmental factors at each tile location are determined. A production facility (e.g., a hydrogen plant) may consider one or more of the following factors: land availability (e.g., green/brownfield), permitting and regulations, population density/proximity, development-related sentiment, water and air factors, local economy/skills base, land cover factors, wildlife and biodiversity, hydrogen storage (production), etc.

The analysis pipeline for the system for determining infrastructure locations further determines the transport (e.g., transport 254) for the project considering economics and GHG emissions at each tile location. For example, the project transport analysis considers hydrogen storage, transport options (e.g., pipelines, roads, marine, etc.).

The analysis pipeline for the system for determining infrastructure locations further determines the offtake (e.g., offtake 256) for the project considering economics and GHG emissions at each tile location. For example, the project offtake analysis considers captive and delivered hydrogen use (e.g., petroleum refineries, co-firing coal power plants, natural gas grid blending, steel, ammonia, methanol, e-fuels, heavy transport, aviation, logistics, etc.). In various embodiments, consumption parameter of an offtaker comprises one of the following: commodity volume, commodity specification, operator credit rating, or operator indications of interest in securing alternative commodity supply, or any other appropriate consumption parameter.

FIG. 2E is a diagram illustrating an embodiment of determining cost associated with a production tile. In some embodiments, cost calculation of FIG. 2E is used by production engine 210 of FIG. 2. In the example shown, the specific input requirements informing per unit costs (e.g., labor, power, water, land) and specific input requirements informing per unit emissions (e.g., power, natural gas) are calculated against the related local variables assigned to each geographic tile to provide estimates of total unit production costs and total unit productions emissions. In some embodiments, these calculations are achieved by formulating an algebraic equation associated with each unique technology profile, which is then calculated against the related local variables assigned to each geographic tile. In some embodiments, calculations include relationships between project variables, based on localized conditions, such as the most cost-effective sizing of input requirements relative to proximate consumption requirements. In some embodiments, the algebraic expression includes variables that are multiplied by weights and summed. In some embodiments, the algebraic expression includes functions (e.g., a minimum function, a maximum function, etc.). In some embodiments, the algebraic expression includes branch type statements (e.g., if-then-else statements, in-the-event statements, case statements, etc.). In some embodiments, the algebraic expression includes linear terms. In some embodiments, the algebraic expression includes non-linear terms. For example, a total localized cost of commodity production comprises a total of labor required times local labor cost plus input power required times local power costs/capacity factor plus input water required times local water costs plus land required times local land costs plus other factors. As another example, total localized GHG emissions of hydrogen production comprise input power required time local power GHG intensity plus input gas required times local natural gas GHG intensity plus other factors. A cost associated with production tile 260 comprises a sum of the total localized cost of commodity production and the total localized GHG emissions of hydrogen production.

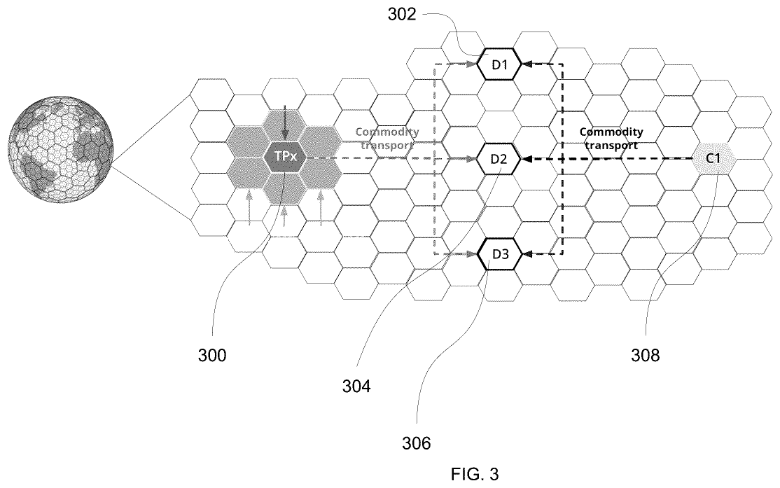

FIG. 3 is a diagram illustrating an embodiment of tiles associated with determining infrastructure locations. In some embodiments, a map geography is split into a set of tiles (e.g., a hexagonal or other uniform shape matrix). For a variety of types of commodity production techniques, a technology profile, which captures the unique input requirements for each technology, is applied against the location-specific input costs at each tile to drive assessment of the economics of production at that tile location. Similarly, for a variety of types of commodity production techniques, a technology profile, which captures the unique input requirements for each technology, is applied against the location-specific input greenhouse gas emissions factors at each tile to drive assessment of the greenhouse gas emissions of production at that tile location. Each tile (e.g., TPx tile 300) can be evaluated as a possible tile location for production. In some embodiments, every tile is evaluated as a possible tile location for production. Demand tile locations (e.g., D1 302, D2 304, and D3 306) for a commodity produced at a production tile location are evaluated for transportation costs between the production tile location and each demand tile location. In some embodiments, the lowest cost transportation cost, emissions, and route are stored as the transportation cost between a production location tile and each demand location tile. In some embodiments, the transport cost, emissions, and route are based on the number and characteristics of transport tiles between the production tiles and demand tiles. In some embodiments the transport tile route is determined by the presence of transport infrastructure present or planned in that geographic location. A competition cost and emissions level are determined for a competitor location tile (e.g., C1 308) to one or more demand locations to be used for comparisons for potential production tile locations.

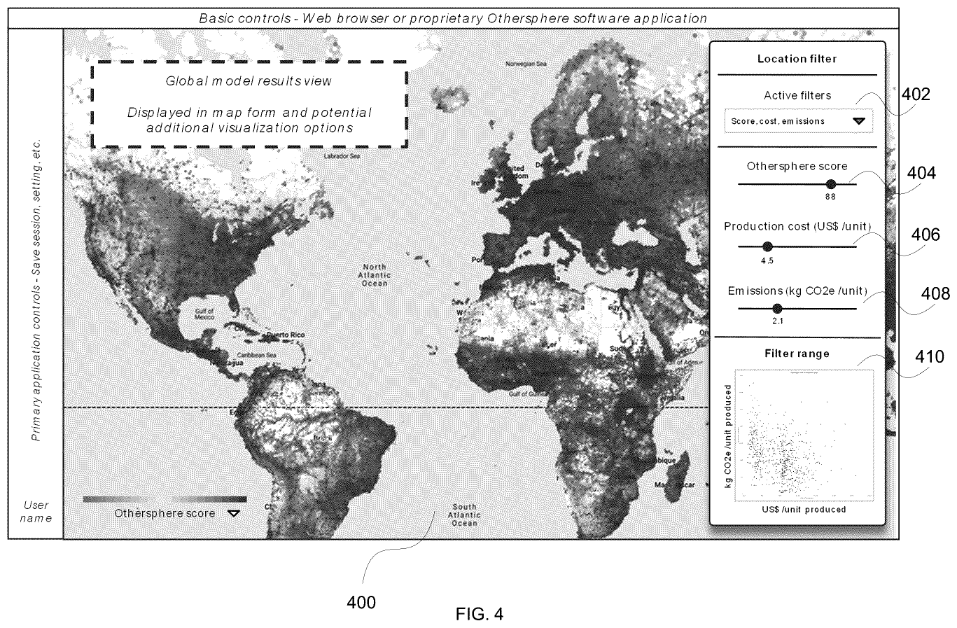

FIG. 4 is a diagram illustrating an embodiment of a user interface for a system determining infrastructure locations. In some embodiments, the user interface is provided by a database system (e.g., database system 108 of FIG. 1). In the example shown, map 400 is shown on the user interface with tile locations that satisfy one or more criteria. For example, the one or more criteria for display include active filter(s) 402 (e.g., score filter 404, cost filter 406, emissions filter 408, etc.). In some embodiments, the display includes a selector for selecting the one or more active filters. In some embodiments, the filter is set using a slide bar to select a value (e.g., a minimum value, a maximum value, etc.). In some embodiments, a selector of the user interface includes a score slider (e.g., an Othersphere score slider—for example, set to 88). In some embodiments, a selector of the user interface includes cost slider (e.g., a production cost slider-for example, set to 4.5 US$/unit). In some embodiments, a selector of the user interface includes an emissions slider (e.g., an emission slider-for example, set to 2.1 kg CO2e/unit). In some embodiments, the user interface includes filter range graph 410 (e.g., with emissions vs production cost graphed).

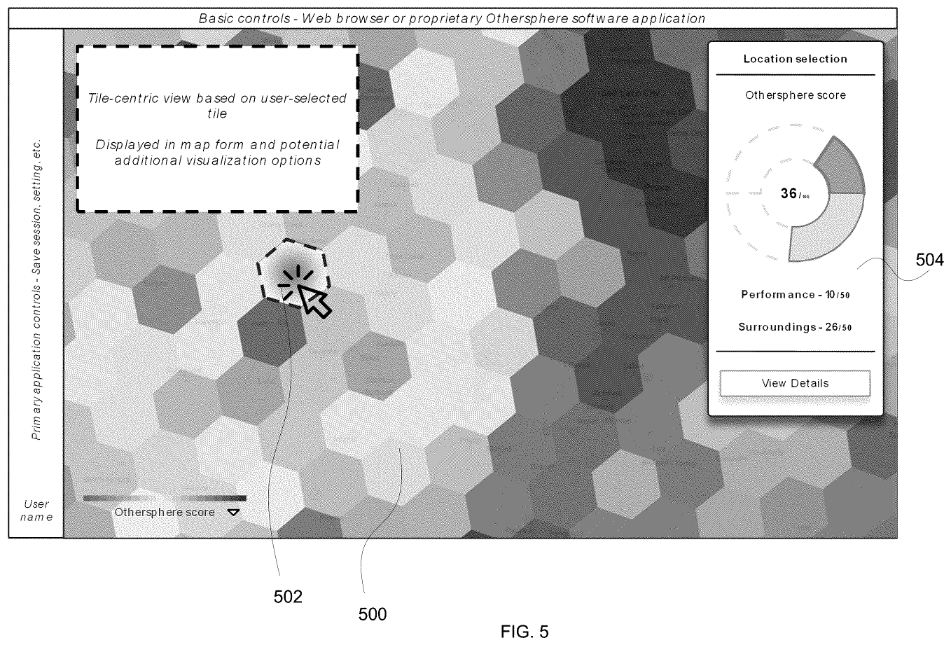

FIG. 5 is a diagram illustrating an embodiment of a user interface for a system determining infrastructure locations. In some embodiments, the user interface is provided by a database system (e.g., database system 108 of FIG. 1). In the example shown, map 500 is shown on the user interface with tile locations that satisfy one or more criteria. For example, the location selection is used to select tile 502 on map 500 (e.g., a cursor is placed on map 500 and used to select tile 502). In some embodiments, the user interface includes a display of summary properties 504 of the selected tile including a score (e.g., an overall score, a performance score, a surrounding score, etc.). In some embodiments, an overall score comprises an Othersphere score that is a ratio (e.g., 36/100). In some embodiments, a performance score comprises a performance score that is a ratio (e.g., 10/50). In some embodiments, a surroundings score comprises a surroundings score that is a ratio (e.g., 26/50).

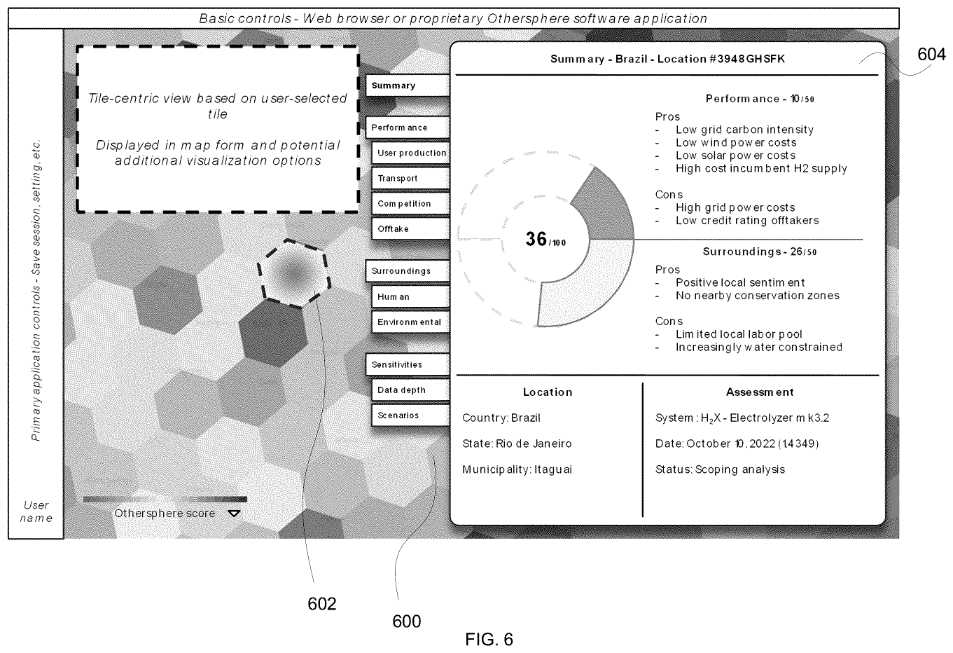

FIG. 6 is a diagram illustrating an embodiment of a user interface for a system determining infrastructure locations. In some embodiments, the user interface is provided by a database system (e.g., database system 108 of FIG. 1). In the example shown, map 600 is shown on the user interface with tile locations that satisfy one or more criteria. For example, the location selection is used to select tile 602 on map 600 (e.g., a cursor is placed on map 600 and used to select tile 602). In some embodiments, performance score comprises a performance score that is a ratio (e.g., 10/50). In some embodiments, summary 604 of a performance score includes pros and cons (e.g., pros: low grid carbon intensity, low wind power costs, low solar power costs, high cost incumbent H2 supply, etc.; cons: high grid power costs, low credit rating offtakers, etc.). In some embodiments, a surroundings score comprises a surroundings score that is a ratio (e.g., 26/50). In some embodiments, summary 604 of a surroundings score includes pros and cons (e.g., pros: positive local sentiment, no nearby conservation zones, etc.; cons: limited local labor pool, increasingly water constrained, etc.). In some embodiments, summary 604 includes location information (e.g., a country name, a state name, a municipality name-such as Brazil, Rio de Janeiro, Itaguai, respectively). In some embodiments, summary 604 includes an assessment-for example, a system assessment name (e.g., H2X—Electrolyzer mk3.2), a month, day, year date information (e.g., Oct. 10, 2022), and a status (e.g., ‘scoping analysis’).

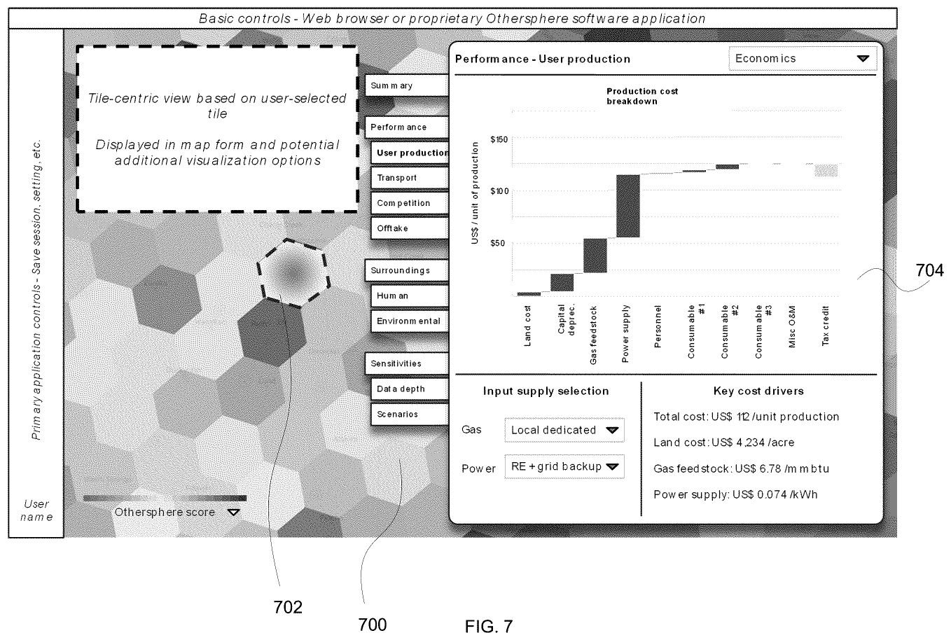

FIG. 7 is a diagram illustrating an embodiment of a user interface for a system determining infrastructure locations. In some embodiments, the user interface is provided by a database system (e.g., database system 108 of FIG. 1). In the example shown, map 700 is shown on the user interface with tile locations that satisfy one or more criteria. For example, the location selection is used to select tile 702 on map 700 (e.g., a cursor is placed on map 704 and used to select tile 702). In some embodiments, user production frame 704 related to performance is shown in a cost breakdown graph-for example, a land cost, a capital depreciation cost, a gas feedstock cost, a power supply cost, a personnel cost, a consumable cost (e.g., a consumable #1, #2, #3, etc.), a miscellaneous O&M cost, a tax credit cost, etc. In some embodiments, user production frame 704 of an input supply selection is included in the user interface (e.g., gas is selected as ‘local dedicated’; power is selected as ‘RE+grid backup’). In some embodiments, user production frame 704 of a key cost summary is displayed-for example, total cost for production (e.g., US$ 112/unit production), land cost for production (e.g., US$ 4,234/acre), gas feedstock for production (e.g., US$ 6.78/mmbtu), power supply for production (e.g., US$ 0.074/kWh), etc.

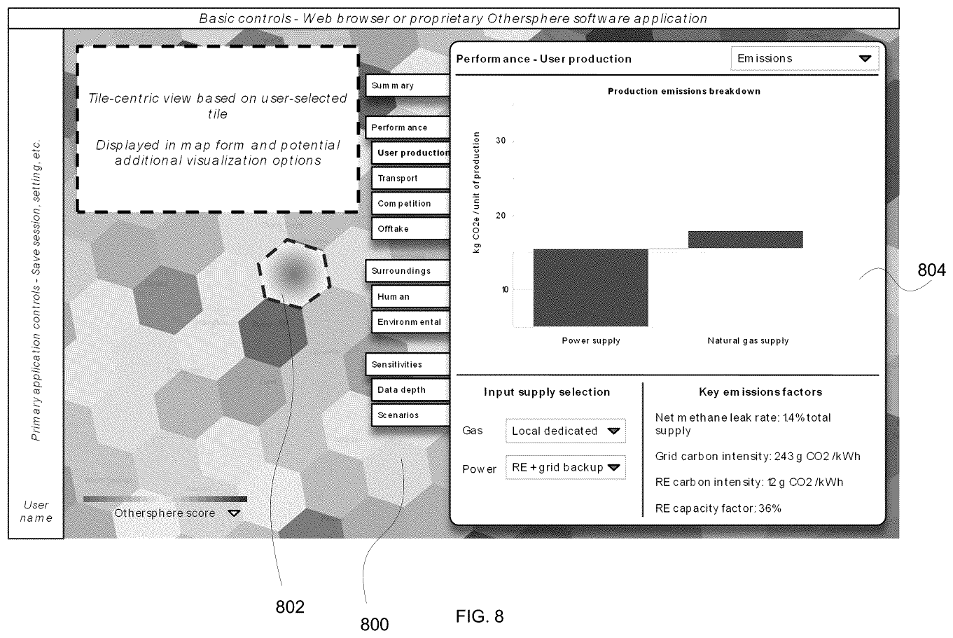

FIG. 8 is a diagram illustrating an embodiment of a user interface for a system determining infrastructure locations. In some embodiments, the user interface is provided by a database system (e.g., database system 108 of FIG. 1). In the example shown, map 800 is shown on the user interface with tile locations that satisfy one or more criteria. For example, the location selection is used to select tile 802 on map 800 (e.g., a cursor is placed on map 800 and used to select tile 802). In some embodiments, user production performance frame 804 production emission is shown in a breakdown graph. For example, a power supply and a natural gas supply emission is shown. In some embodiments, user production performance frame 804 of an input supply selection is included in the user interface (e.g., gas is selected as ‘local dedicated’; power is selected as ‘RE+grid backup’). In some embodiments, user production performance frame 804 of a key emissions factors summary is displayed—for example, net methane leak rate (e.g., 1.4% total supply), grid carbon intensity (e.g., 243 CO2/kWh), RE carbon intensity (e.g., 12g CO2/kWh), RE capacity factor (e.g., 36%).

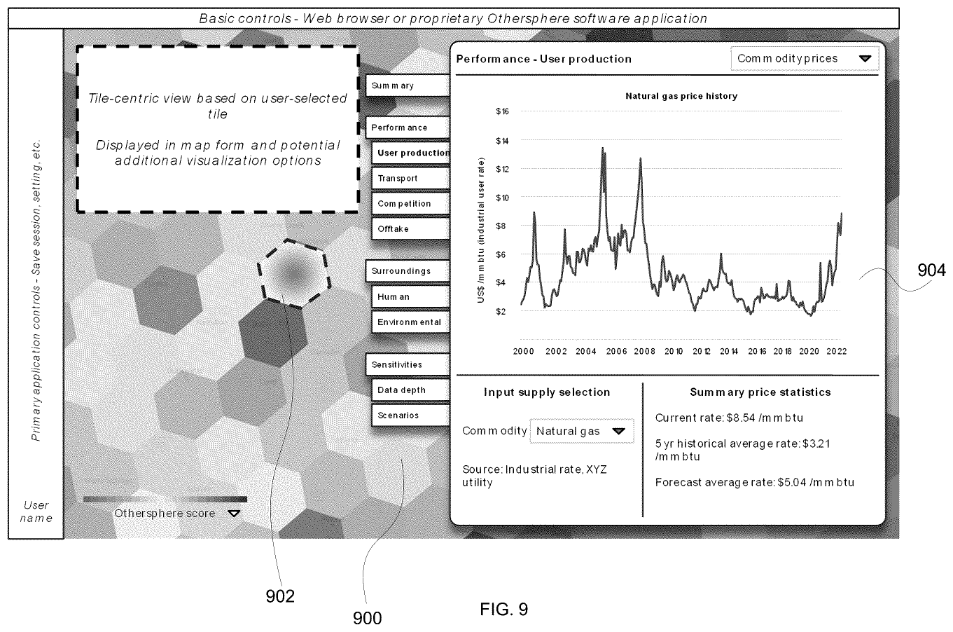

FIG. 9 is a diagram illustrating an embodiment of a user interface for a system determining infrastructure locations. In some embodiments, the user interface is provided by a database system (e.g., database system 108 of FIG. 1). In the example shown, map 900 is shown on the user interface with tile locations that satisfy one or more criteria. For example, the location selection is used to select tile 902 on map 900 (e.g., a cursor is placed on map 900 and used to select tile 902). In some embodiments, natural gas price history graph or a natural gas price projection graph are shown in user production performance frame 904 to provide users transparency into how underlying production performance results are calculated. In some embodiments, the user interface includes an input supply selection (e.g., commodity ‘natural gas’) and a source display (e.g., industrial rate, XYZ utility). In some embodiments, a summary price statistic is shown (e.g., a current rate (e.g., $8.54/mmbtu), a 5 yr historical average rate (e.g., $3.21/mmbtu), and a forecast average rate (e.g., $5.04/mmbtu). In some embodiments, a user is able to input price projection data.

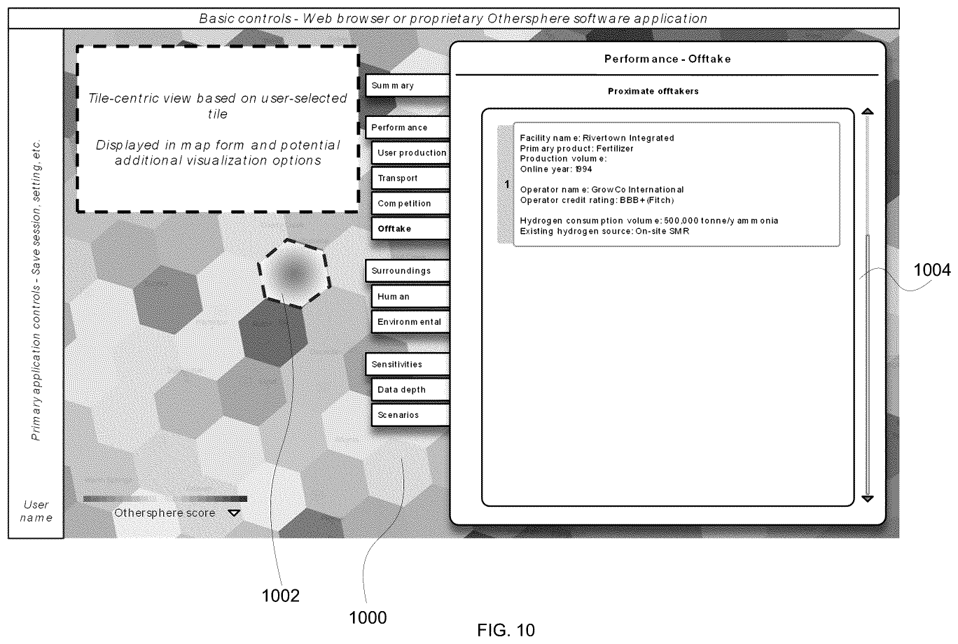

FIG. 10 is a diagram illustrating an embodiment of a user interface for a system determining infrastructure locations. In some embodiments, the user interface is provided by a database system (e.g., database system 108 of FIG. 1). In the example shown, map 1000 is shown on the user interface with tile locations that satisfy one or more criteria. For example, the location selection is used to select tile 1002 on map 1000 (e.g., a cursor is placed on map 1000 and used to select tile 1002). In some embodiments, performance offtakers frame 1004 are shown (e.g., proximate offtakes). In some embodiments, a facility name (e.g., Rivertown Integrated), a primary product name (e.g., Fertilizer), a production volume, an online year (e.g., 1994), an operator name (e.g., GrowCo International), an operator credit (e.g., BBB+ (Fitch)), a hydrogen consumption volume (e.g., 500,000 tonne/y ammonia), an existing hydrogen source (e.g., on-site SMR), etc. are shown. In some embodiments, the aggregated hydrogen consumption within a commercially-viable distance of a tile, shown in the proximate offtaker list, is used to inform the production performance calculation.

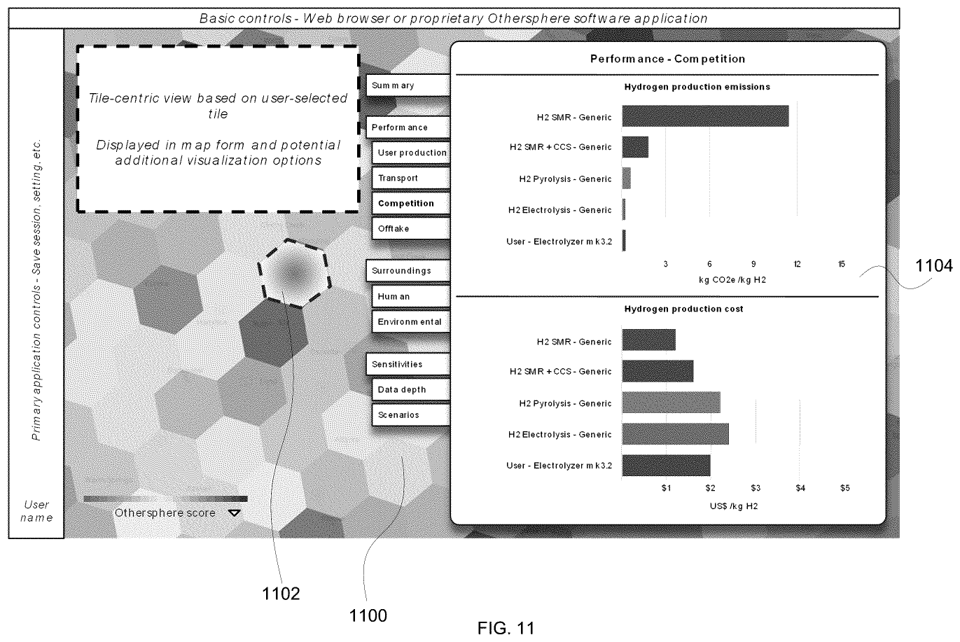

FIG. 11 is a diagram illustrating an embodiment of a user interface for a system determining infrastructure locations. In some embodiments, the user interface is provided by a database system (e.g., database system 108 of FIG. 1). In the example shown, map 1100 is shown on the user interface with tile locations that satisfy one or more criteria. For example, the location selection is used to select tile 1102 on map 1100 (e.g., a cursor is placed on map 1100 and used to select tile 1102). In some embodiments, performance competition frame 1104 is shown using graphs—for example, hydrogen production emission graph and a hydrogen production cost graph. In some embodiments, H2 SMR—Generic, H2 SMR+CCS—Generic, H2 Pyrolysis—Generic, H2 Electrolysis—Generic, and User—Electrolyzer mk3.2 production emissions are shown. In some embodiments, H2 SMR—Generic, H2 SMR+CCS—Generic, H2 Pyrolysis—Generic, H2 Electrolysis—Generic, and User—Electrolyzer mk3.2 production costs are shown.

In some embodiments, the system includes optimization for production tiles. The optimizer intelligently searches the space of all possible production configurations for a project in a tile, aiming to find the configuration with the lowest cost of hydrogen production. The optimizer searches through configurable values such as the capacity of the hydrogen electrolyzer, the capacity of any installed co-located renewable power production, the size of any on-site hydrogen storage, and how much electricity to pull from the grid and during which hours of the year. In some cases, the optimizer will satisfy constraints provided by the user, including maximum levels of CO₂ produced per unit hydrogen, and minimum levels of production output to meet proximal demand, finding the cheapest production configuration which does not violate these constraints. To facilitate this search the optimizer uses a range of values such as hourly grid power price, hourly wind capacity factor, hourly solar capacity factor, and hourly grid carbon intensity, at the individual site level.

In some embodiments, a neural network model is trained to approximate the output of the site level optimizer at much greater speeds. Training examples for this network are generated using the much slower site-level optimizer. These examples are site level datasets, including hourly data, as inputs, and optimized project configuration parameters, such as electrolyzer stack size and installed co-located renewable capacity, as outputs, which are calculated by running the site-level optimizer. This neural network-based surrogate for the optimizer can then be run over the 180M+ tiles that are indexed. Note that the site-level optimizer, which is millions of times slower than the neural network based optimizer, would require millions of times more CPU power, and hence time and cost for this task. Functionally, this will allow users to more effectively search for sites from the outset, as the initial values that the users see will be closer to the post-optimized versions. In some embodiments, a user provides inputs and a neural network model (after being trained on a preexisting data set) is used to determine an initial state for tiles, then the tiles are optimized using the full calculation optimizer to determine an updated state for tiles; a user then can revise inputs to cycle the neural network model and the full calculation optimizer again to generate revised outputs.

In some embodiments, in order to speed processing, a neural network model or other form of large predictive model are developed using outputs from system-level analysis. In some embodiments this would include comparing combinations of production tiles, transport tiles, and demand tiles for a hydrogen project, against combinations of production tiles, transport tiles, and demand tiles for a steel production project at a particular location. This might also include the same comparison across a range of other infrastructure use cases at a particular location. Training large-scale predictive models based on the outputs from deterministic models built for specific individual infrastructure use cases will allows users to more effectively search for ideal locations based on competing land use considerations.

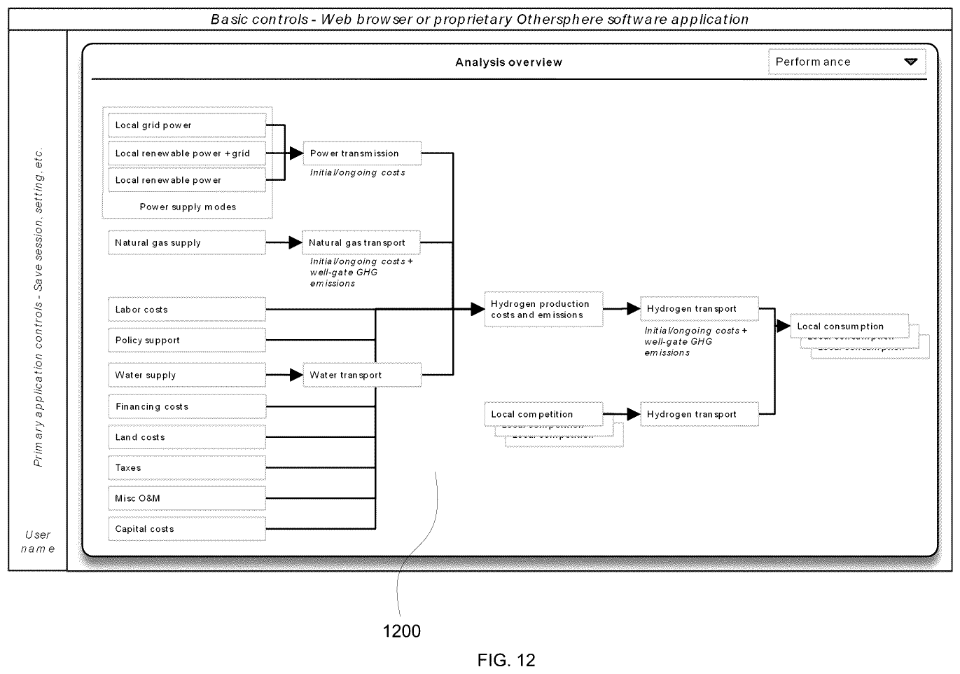

FIG. 12 is a diagram illustrating an embodiment of a user interface for a system determining infrastructure locations. In some embodiments, the user interface is provided by a database system (e.g., database system 108 of FIG. 1). In the example shown, map was shown on the user interface with tile locations that satisfy one or more criteria. For example, the location selection was used to select a tile on the map (e.g., a cursor is placed on the map and used to select the tile). In some embodiments, analysis overview 1200 is shown for the selected tile. In some embodiments, power supply modes are analyzed (e.g., local grid power, local renewable power+grid, and local renewable power supply modes). In some embodiments, the local power supply modes are used to determine power costs including transmission costs (e.g., initial and ongoing costs). In some embodiments, natural gas supply costs and natural gas transport costs (e.g., initial and ongoing costs+well-gate CHG emissions) are determined. In some embodiments, labor costs, policy support costs, water supply costs, water transport costs (e.g., initial and ongoing costs), financing costs, land costs, taxes, miscellaneous O&M, and capital costs are determined. In some embodiments, the above are used for determining hydrogen production costs and emissions as well as hydrogen transport costs (e.g., initial and ongoing costs+well-gate CHG emissions). In some embodiments, local competition costs for hydrogen and transportation costs are determined.

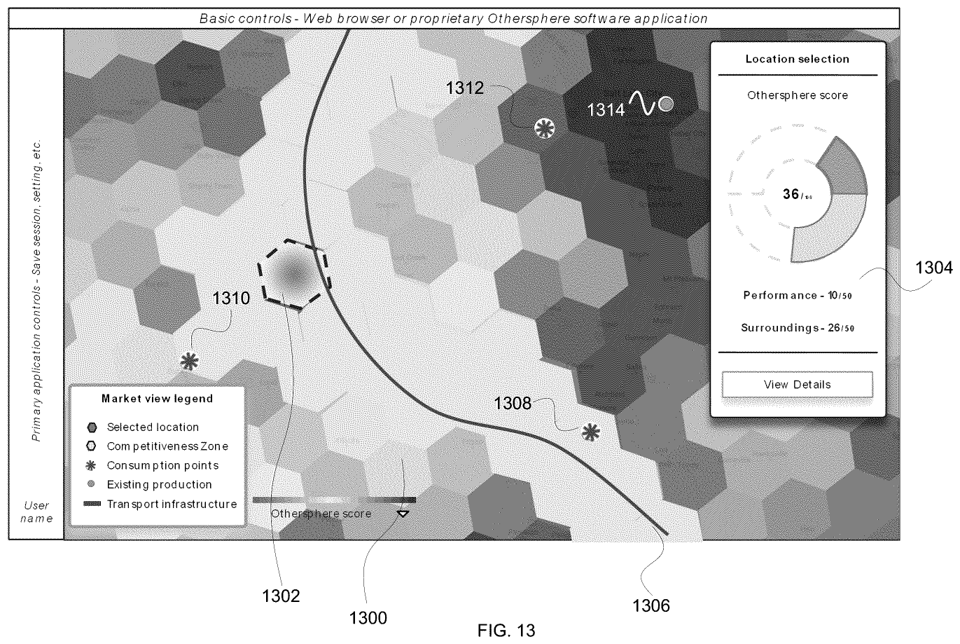

FIG. 13 is a diagram illustrating an embodiment of a user interface for a system determining infrastructure locations. In some embodiments, the user interface is provided by a database system (e.g., database system 108 of FIG. 1). In the example shown, map 1300 is shown on the user interface with tile locations that satisfy one or more criteria. For example, the location selection is used to select tile 1302 on map 1300 (e.g., a cursor is placed on map 1300 and used to select tile 1302—shown as the reddish tile with a dashed boundary). The tile locations with a yellow color indicate a competitive zone (e.g., a tile associated with favorable economics compared to other tiles with a gray scale coding of an Othersphere score). The location of a consumption point is indicated using red star 1308, red star 1310, and red star 1312. An existing production location is indicated by green circle 1314 that is smaller than a tile.

Existing transportation infrastructure is indicated by line 1306 (e.g., the purple line running through the competitive zone (e.g., marked by yellow tiles). In some embodiments, a color code is shown for a plurality of tiles (e.g., a blue for a low Othersphere score, a green for a higher Othersphere score, a yellow for a next higher Othersphere score, an orange for a next next higher Othersphere score, and a red for a highest Othersphere score). In some embodiments, an overall score is shown on score frame 1304 which comprises an Othersphere score that is a ratio (e.g., 36/100 for selected tile). In some embodiments, a performance score comprises a performance score that is a ratio (e.g., 10/50 for selected tile). In some embodiments, a surroundings score comprises a surroundings score that is a ratio (e.g., 26/50 for selected tile).

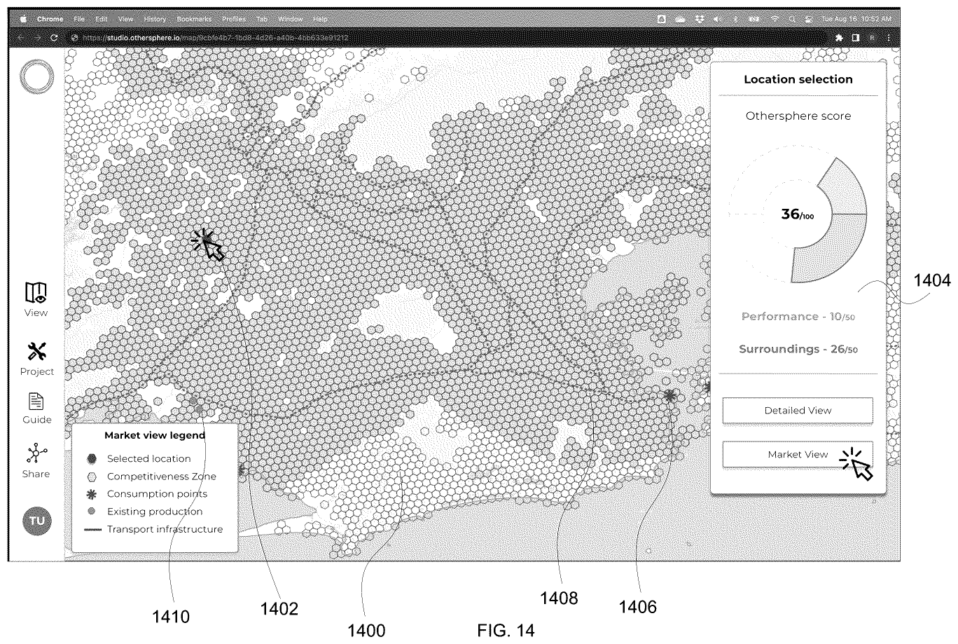

FIG. 14 is a diagram illustrating an embodiment of a user interface for a system determining infrastructure locations. In some embodiments, the user interface is provided by a database system (e.g., database system 108 of FIG. 1). In some embodiments, FIG. 14 represents a larger map view similar to FIG. 13. In the example shown, map 1400 is shown on the user interface with tile locations that satisfy one or more criteria. For example, the location selection is used to select tile 1402 on map 1400 (e.g., a cursor is placed on map 1400 and used to select tile 1402). In some embodiments, a color code is shown for a plurality of tiles (e.g., a yellow for a competitiveness zone, purple with dashed line for a selected location, a red for consumption point 1406, a green for existing production shown as circle 1410, a purple line 1408 for a transport infrastructure). In some embodiments, an overall score shown in location selection frame 1404 comprises an Othersphere score that is a ratio (e.g., 36/100 for selected tile). In some embodiments, a performance score comprises a performance score that is a ratio (e.g., 10/50 for selected tile). In some embodiments, a surroundings score comprises a surroundings score that is a ratio (e.g., 26/50 for selected tile). In some embodiments, the competitiveness zone color coding (yellow) is used to highlight the tiles which could be served in a commercially-viable manner from tile 1402 (purple). Consumption points are indicated using red stars (e.g., consumption point 1406) and existing production locations are indicated using a green circle (e.g., circle 1410).

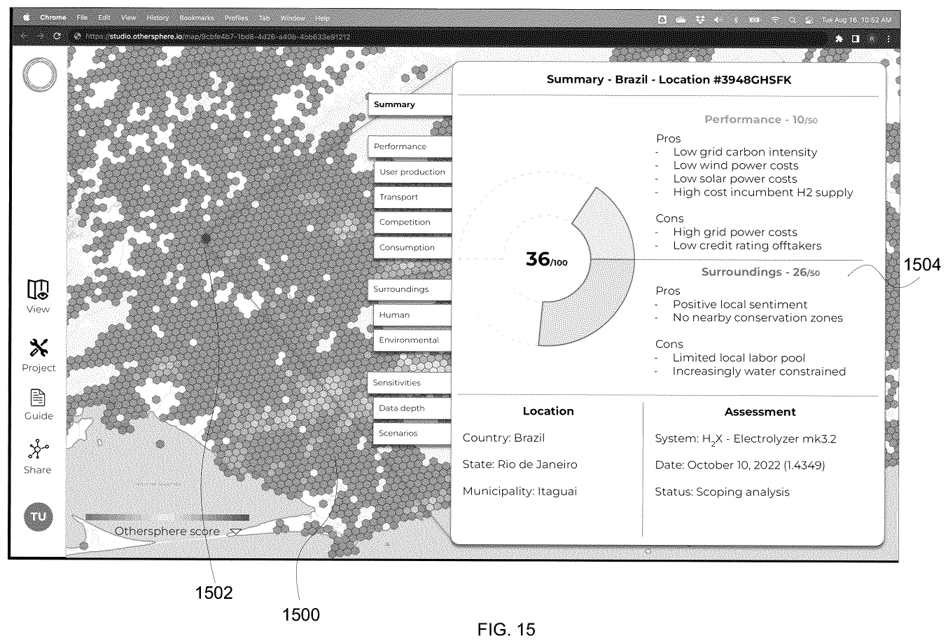

FIG. 15 is a diagram illustrating an embodiment of a user interface for a system determining infrastructure locations. In some embodiments, the user interface is provided by a database system (e.g., database system 108 of FIG. 1). In the example shown, map 1500 is shown on the user interface with tile locations that satisfy one or more criteria. For example, the location selection is used to select tile 1502 on map 1500 (e.g., a cursor is placed on map 1500 and used to select tile 1502). In some embodiments, summary frame 1504 is shown. In some embodiments, summary frame 1504 comprises a performance score comprises a performance score that is a ratio (e.g., 10/50). In some embodiments, a summary of a performance score includes pros and cons (e.g., pros: low grid carbon intensity, low wind power costs, low solar power costs, high cost incumbent H2 supply, etc.; cons: high grid power costs, low credit rating offtakers, etc.). In some embodiments, a surroundings score comprises a surroundings score that is a ratio (e.g., 26/50). In some embodiments, a summary of a surroundings score includes pros and cons (e.g., pros: positive local sentiment, no nearby conservation zones, etc.; cons: limited local labor pool, increasingly water constrained, etc.). In some embodiments, the user interface includes location information (e.g., a country name, a state name, a municipality name-such as Brazil, Rio de Janeiro, Itaguai, respectively). In some embodiments, the user interface includes an assessment-for example, a system assessment name (e.g., H2X—Electrolyzer mk3.2), a month, day, year date information (e.g., Oct. 10, 2022), and a status (e.g., ‘scoping analysis’).

In some embodiments, a plurality of tiles are shown color coded for a given score (e.g., an Othersphere score).

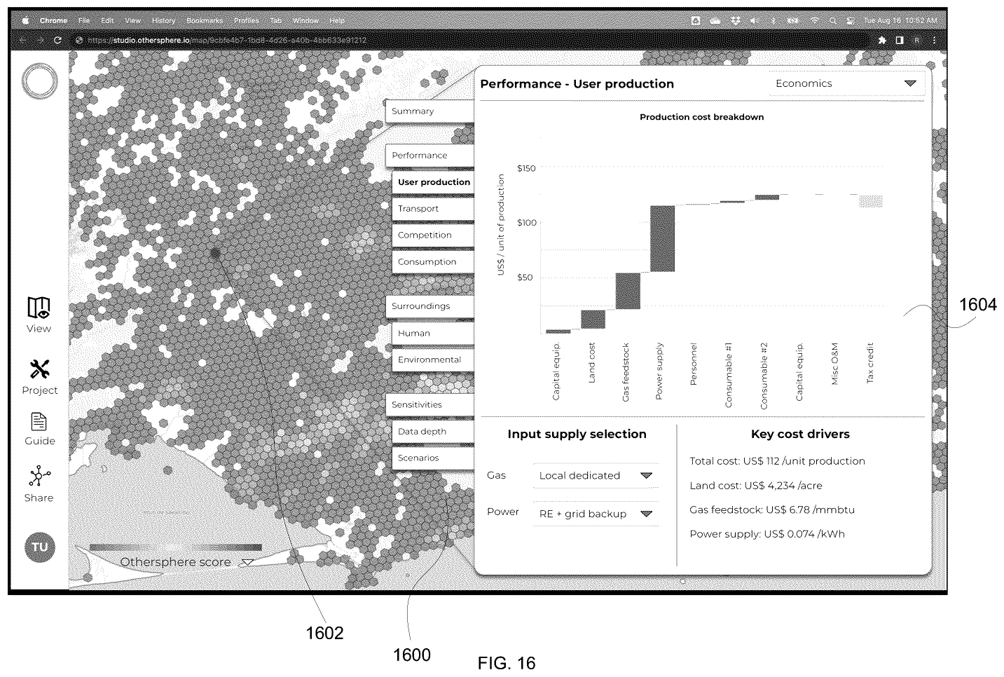

FIG. 16 is a diagram illustrating an embodiment of a user interface for a system determining infrastructure locations. In some embodiments, the user interface is provided by a database system (e.g., database system 108 of FIG. 1). In the example shown, map 1600 is shown on the user interface with tile locations that satisfy one or more criteria. For example, the location selection is used to select tile 1602 on map 1600 (e.g., a cursor is placed on map 1600 and used to select tile 1602). In some embodiments, user production frame 1604 is shown related to performance and specifically is shown in a cost breakdown graph-for example, a land cost, a capital depreciation cost, a gas feedstock cost, a power supply cost, a personnel cost, a consumable cost (e.g., a consumable #1, #2, #3, etc.), a miscellaneous O&M cost, a tax credit cost, etc. In some embodiments, an input supply selection is included in the user interface (e.g., gas is selected as ‘local dedicated’; power is selected as ‘RE+grid backup’). In some embodiments, a key cost summary is displayed-for example, total cost for production (e.g., US$ 112/unit production), land cost for production (e.g., US$ 4,234/acre), gas feedstock for production (e.g., US$ 6.78/mmbtu), power supply for production (e.g., US$ 0.074/kWh), etc. In some embodiments, a plurality of tiles are shown color coded for a given score (e.g., an Othersphere score).

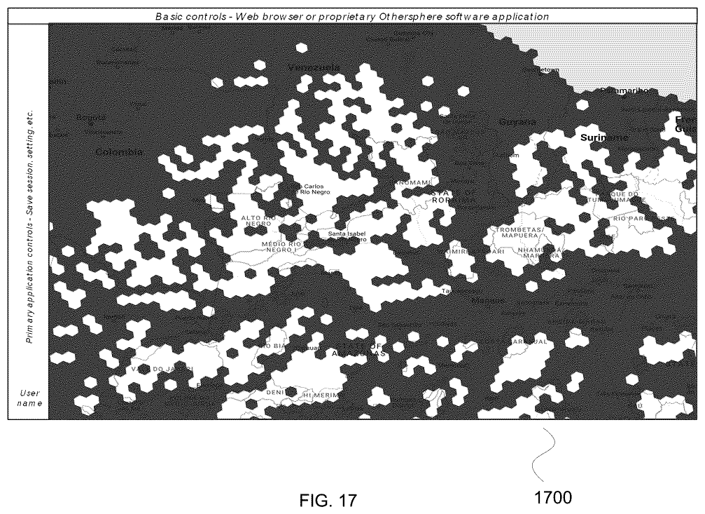

FIG. 17 is a diagram illustrating an embodiment of a user interface for a system determining infrastructure locations. In some embodiments, the user interface is provided by a database system (e.g., database system 108 of FIG. 1). In the example shown, map 1700 is shown on the user interface with tile locations that satisfy one or more criteria. For example, the location selection is used to select a tile on map 1700 (e.g., a cursor is placed on map 1700 and used to select the tile). In some embodiments, fit with surroundings is determined relative to criteria such as the presence or absence of government-mandated biodiversity protection areas. In some embodiments, whether a tile is subject to biodiversity protection area rulings will be factored into Othersphere score and other derived outputs to users. In some embodiments, whether a tile is subject to government-mandated biodiversity protection areas may be visually highlighted through color coded tiles overlay on user interface map. In some embodiments, whether a tile is subject to government-mandated biodiversity protection areas may exclude this tile from recommendations or be otherwise indicated to users as a less opportune location to be included in a project.

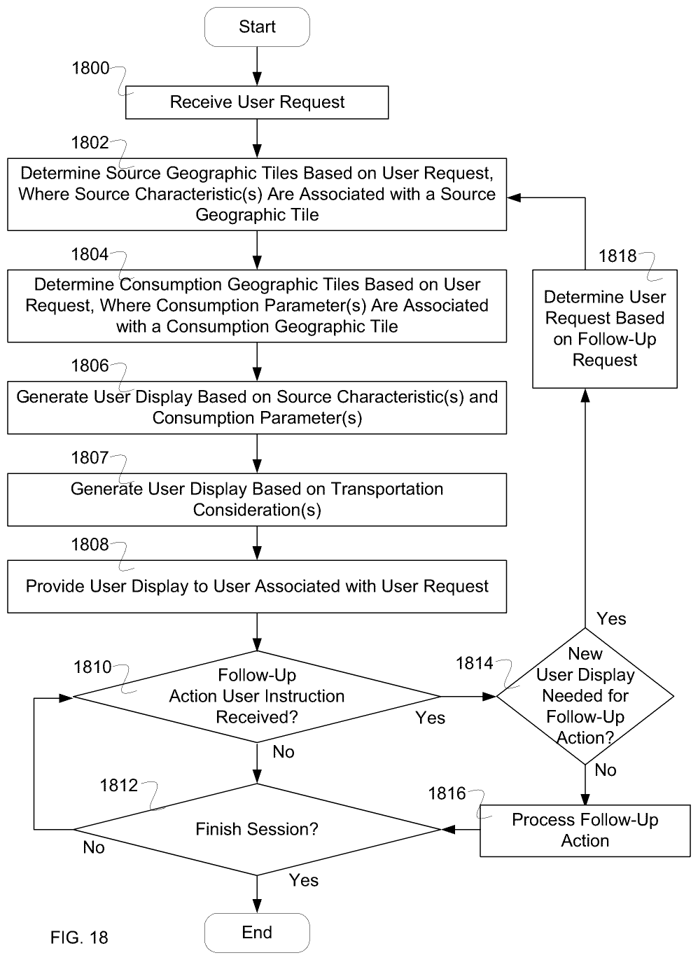

FIG. 18 is a flow diagram illustrating an embodiment of a process for determining infrastructure locations. In some embodiments, the process of FIG. 18 is implemented using database system 108 of FIG. 1 and/or database system 200 of FIG. 2. In the example shown, in 1800 a user request is received. For example, a user requests information regarding a potential location for placing infrastructure. In 1802, source geographic tiles are determined based on the user request, where the source characteristic(s) are associated with a source geographic tile. For example, the system determines characteristics for tile(s) as potential locations for being a source for a commodity. In some embodiments, different potential characteristics are explored as options-for example, different production technologies and their impacts on emissions, intake resources (e.g., water, fuel, electricity, etc.), and acceptability for local communities. In 1804, consumption geographic tiles are determined based on the user request, where the consumption parameter(s) are associated with a consumption geographic tile. For example, the system determines parameters for tile(s) as locations as consumers of a commodity produced at a source geographic tile. In 1806, a user display is generated based on source characteristic(s) and on consumption parameter(s). For example, tile locations are associated with source and consumption information including how the source uses resources to produce a commodity and where the commodity may be provided (e.g., as a consumable). In 1807, a user display is generated based on transportation considerations. For example, between a given source geographic tile and a given consumption geographic tile the transportation cost, emissions, etc. are determined using routes that consider the number of tiles (transport tiles) between a production tile and a demand tile. In 1808, a user display is provided to a user associated with a user request. For example, the generated user display including a display of information related to source geographic tiles, consumption geographic tiles, and transportation between source geographic tiles and consumption geographic tiles. In 1810, it is determined whether a follow-up action user instruction has been received. In response to determining a follow-up action user instruction having been received, control passes to 1814. In response to determining a follow-up action user instruction having not been received, control passes to 1812. In 1812, it is determined whether the session is finished. In response to determining that the session is finished, the process ends. In response to determining that the session is not finished, control passes to 1810. In 1814, it is determined whether a new user display is needed for the follow-up action. In response to determining that a new user display is not needed for the follow-up action, control passes to 1816, where the follow-up action is processed and control passes to 1812. In response to determining that a new user display is needed for the follow-up action, control passes to 1818, where a user request is determined based on the follow-up request, and control passes to 1802.

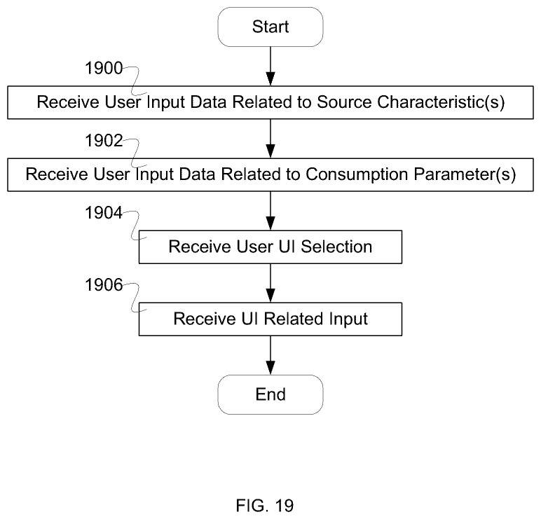

FIG. 19 is a flow diagram illustrating an embodiment of a process for receiving a user request. In some embodiments, the process of FIG. 19 is used to implement 1800 of FIG. 18. In the example shown, in 1900 a user input data is received related to source characteristic(s). In 1902, user input data is received related to consumption parameter(s). In 1904, user UI selection is received. In 1906, UI related input is received.

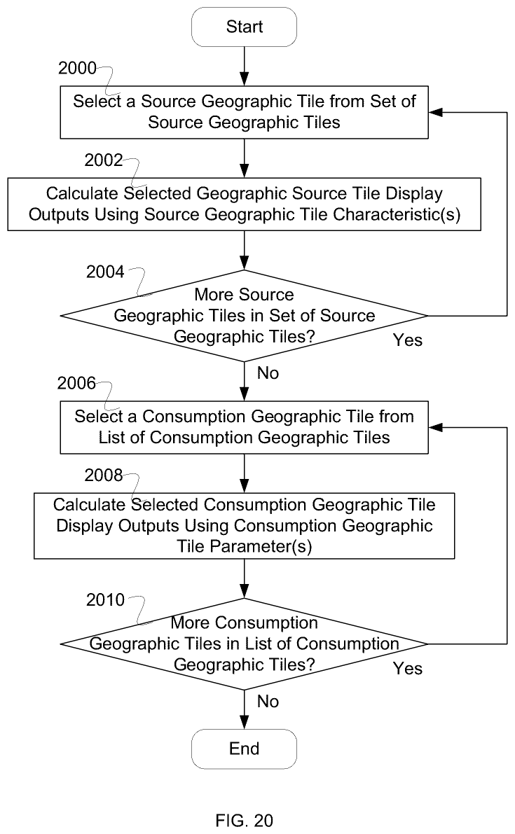

FIG. 20 is a flow diagram illustrating an embodiment of a process for generating a display. In some embodiments, the process of FIG. 20 is used to implement 1806 of FIG. 18. In the example shown, in 2000, a source geographic tile is selected from a set of source geographic tiles. In 2002, selected geographic source tile display outputs are calculated using source geographic tile characteristic(s). In 2004, it is determined whether there are more source geographic tiles in the set of source geographic tiles. In response to there being more source geographic tiles in the set of source geographic tiles, control passes to 2000. In response to there not being more source geographic tiles in the set of source geographic tiles, control passes to 2006. In 2006, a consumption geographic tile is selected from a list of consumption geographic tiles. In 2008, selected geographic consumption tile display outputs are calculated using source consumption tile parameter(s). In 2004, it is determined whether there are more consumption geographic tiles in the list of consumption geographic tiles. In response to there being more consumption geographic tiles in the list of consumption geographic tiles, control passes to 2006. In response to there not being more consumption geographic tiles in the list of consumption geographic tiles, the process ends. In some embodiments, the selection of a source geographic tile leads to the automated calculation of recommended consumption geographic tiles with users having the option to select all or a subset the recommended consumption geographic tiles.

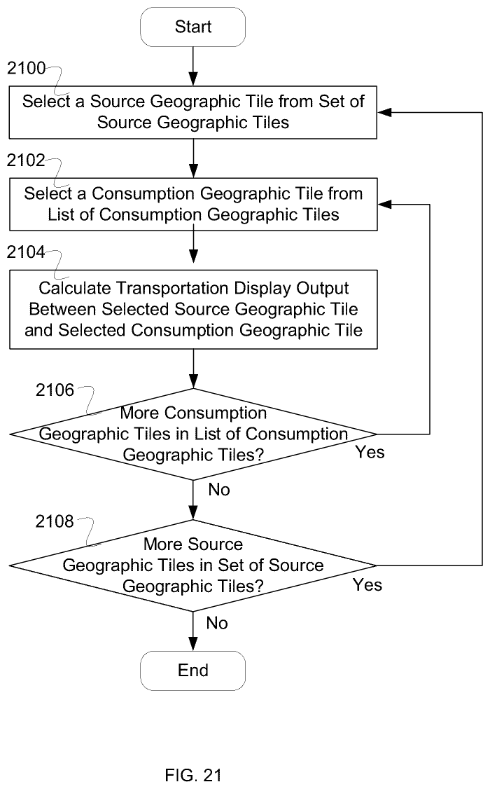

FIG. 21 is a flow diagram illustrating an embodiment of a process for generating a display. In some embodiments, the process of FIG. 21 is used to implement 1808 of FIG. 18. In the example shown, in 2100 a source geographic time is selected from the set of source geographic tiles. In 2102 a consumption geographic tile is selected from the list of consumption geographic tiles. In 2104, a transportation display output is calculated between the selected source geographic tile and the selected consumption geographic tile. In 2106, it is determined whether there are more consumption geographic tiles in the list of consumption geographic tiles. In response to there being more consumption geographic tiles in the list of consumption geographic tiles, control passes to 2102. In response to there not being more consumption geographic tiles in the list of consumption geographic tiles, control passes to 2108. In 2108, it is determined whether there are more source geographic tiles in the set of source geographic tiles. In response to there being more source geographic tiles in the set of source geographic tiles, control passes to 2100. In response to there not being more source geographic tiles in the set of source geographic tiles, the process ends.

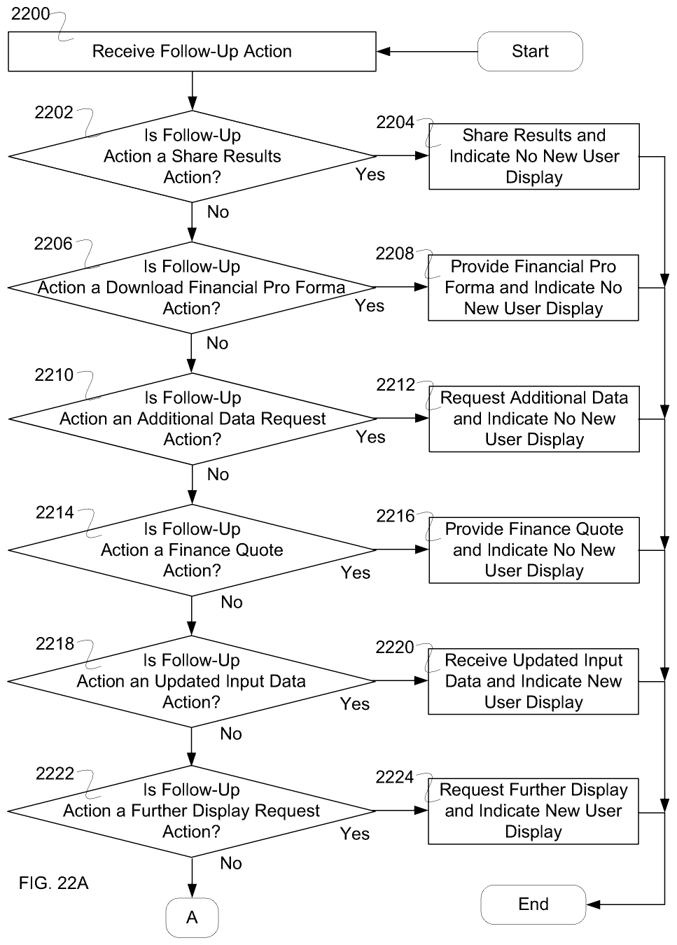

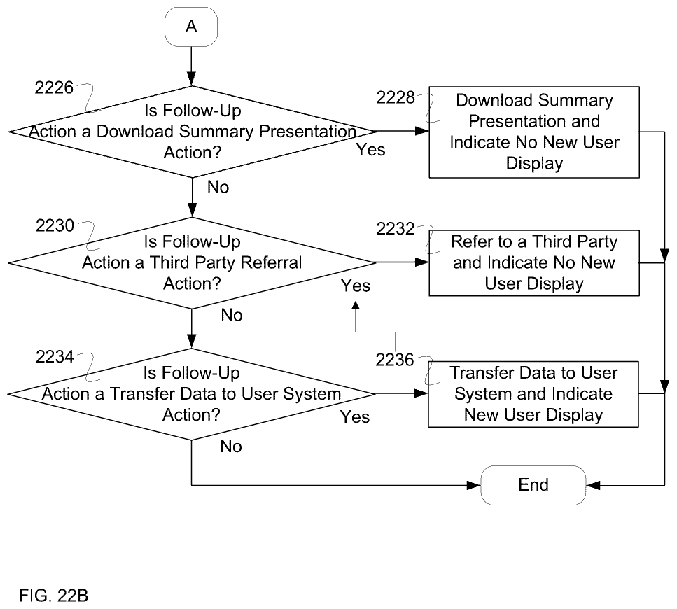

FIGS. 22A and 22B are a flow diagram illustrating an embodiment of a process for determining whether a new user display is needed. In some embodiments, the process of FIG. 22 is used to implement 1814 of FIG. 18. In the example shown, in 2200 a follow-up action is received. In 2202, it is determined whether the follow-up action is a share results action. In response to the follow-up action being a share results action, control passes to 2204. In 2204, results are shared, and it is indicated that no new user display is needed, and the process ends. In response to the follow-up action not being a share results action, control passes to 2206. In 2206, it is determined whether the follow-up action is a download financial pro forma action. In response to the follow-up action being a download financial pro forma action, control passes to 2208. In 2208, financial pro forma is provided, and it is indicated that no new user display is needed, and the process ends. In response to the follow-up action not being a download financial pro forma action, control passes to 2210. In 2206, it is determined whether the follow-up action is a download financial pro forma action. In response to the follow-up action being a download financial pro forma action, control passes to 2208. In 2208, financial pro forma is provided, and it is indicated that no new user display is needed, and the process ends. In response to the follow-up action not being a download financial pro forma action, control passes to 2210. In 2210, it is determined whether the follow-up action is an additional data request action. In response to the follow-up action being an additional data request action, control passes to 2212. In 2212, an additional data is requested, and it is indicated that no new user display is needed, and the process ends. In response to the follow-up action not being an additional data request action, control passes to 2214. In 2214, it is determined whether the follow-up action is a finance quote action. In response to the follow-up action being a finance quote action, control passes to 2216. In 2216, a finance quote is provided, and it is indicated that no new user display is needed, and the process ends. In response to the follow-up action not being a finance quote action, control passes to 2218. In 2218, it is determined whether the follow-up action is an updated input data action. In response to the follow-up action being an updated input data action, control passes to 2220. In 2220, an updated input data is received, and it is indicated that a new user display is needed, and the process ends. In response to the follow-up action not being an updated input data action, control passes to 2222. In 2222, it is determined whether the follow-up action is a further display request action. In response to the follow-up action being a further display request action, control passes to 2224. In 2224, a further display request is received, and it is indicated that a new user display is needed, and the process ends. In response to the follow-up action not being a further display request action, control passes to 2226. In 2226, it is determined whether the follow-up action is a download summary presentation action. In response to determining that the follow-up action is a download summary presentation action, control passes to 2228. In 2228, a summary presentation is downloaded and no new user display is indicated, and the process ends. In response to determining the follow-up action is not a download summary presentation action, control passes to 2230. In 2230, it is determined whether the follow-up action is a third party referral action. In response to determining that the follow-up action is a third party referral action, control passes to 2232. In 2232, a third party is referred to and no new user display is indicated, and the process ends. In response to determining that the follow-up action is not a third party referral action, control passes to 2234. In 2234, it is determined whether the follow-up action is a transfer data to user system action. In response to determining that the follow-up action is a transfer data to user system action, control passes to 2236. In 2236, data is transferred to user system and no new user display is indicated, and the process ends. In response to determining that the follow-up action is not a transfer data to user system action, and the process ends.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system comprising:
an interface configured to:
receiving a user request;
a processor configured to:
determine a set of source geographic tiles based at least in part on the user request, wherein one or more source characteristics are associated with a source geographic tile of the set of source geographic tiles;
determine a list of consumption geographic tiles, wherein one or more consumption parameters are associated with a consumption geographic tile of the list of consumption geographic tiles;
generate a user display based at least in part on the one or more source characteristics and on the one or more consumption parameters; and
provide the user display to a user associated with the user request.

2. The system of claim 1, wherein the user request includes user data related to a specified source geographic tile.

3. The system of claim 1, wherein the user request includes user data related to a specified consumption geographic tile.

4. The system of claim 1, wherein the source geographic tile of the set of source geographic tiles comprises a hexagonal shaped geographic area.

5. The system of claim 1, wherein the consumption geographic tile of the list of consumption geographic tiles comprises a hexagonal shaped geographic area.

6. The system of claim 1, wherein a source characteristic of the one or more source characteristics comprises one of the following: an economic characteristic, an emission characteristic, or a fit characteristic.

7. The system of claim 1, wherein the source characteristic of the one or more source characteristics comprises a fit characteristic, wherein the fit characteristic comprises one of the following: a water supply fit, a biodiversity impact fit, an air quality fit, a population fit, a human constraint fit, an environmental constraint fit, a flood risk fit, a wildfire risk fit, a local sentiment fit, a corruption risk fit, or a permit risk fit.

8. The system of claim 1, wherein a consumption parameter of the one or more consumption parameters comprises one of the following: commodity volume, commodity specification, operator credit rating, or operator indications of interest in securing alternative commodity supply.

9. The system of claim 1, wherein the user display generated based at least in part on a transportation consideration.

10. The system of claim 9, wherein the transportation consideration is associated with one or more of road transportation, rail transportation, pipeline transportation, and/or marine transportation.

11. The system of claim 9, wherein the transportation consideration is based at least in part on transporting an output from a selected source geographic tile to a selected consumption geographic tile.

12. The system of claim 9, wherein the transportation consideration is associated with new transportation routes taking economics, emissions, and fit into account.

13. The system of claim 1, wherein the graphic user display comprises one or more of the following: a global assessment view, a global rank view, a primary project view, a project node view, an economics breakdown view, an economic outlook view, a greenhouse gas breakdown view, a competition breakdown view, a project competitiveness view, a customer breakdown view, a transportation breakdown view, a surroundings summary view, a scenario view, an uncertainty view, a project design summary view, a performance analysis summary view, a surroundings analysis summary view, a location summary view, a time series view, a facility data view, a filter view, a supply chain view, a results summary view, a performance summary economics view, a performance summary emissions view, a performance summary consumption view, a data depth view, a selection view, or a data confidence view.

14. The system of claim 1, further comprising receiving a user instruction for a follow-up action.

15. The system of claim 14, wherein the follow-up action comprises one or more of the following: a share results action, a download financial pro forma action, a download summary presentation action, an additional data request action, a third party referral action, a finance quote action, an update input data action, an action to transfer data to user system, or a further display request action.

16. The system of claim 14, wherein a follow-up action comprises an update input data action, wherein the update input data action comprises receiving updated input data, generating an updated user display based at least in part on the updated input data, and providing the updated user display to the user.

17. The system of claim 14, wherein a follow-up action comprises a further display request action, wherein the further display request action comprises receiving updated display request, generating an updated user display based at least in part on the updated display request, and providing the updated user display to the user.

18. The system of claim 1, wherein the user display includes confidence data.

19. The system of claim 18, wherein the confidence data is based at least in part on reliability data associated with system input data.

20. The system of claim 1, wherein generating the user display is based at least in part on an algebraic expression based at least in part on the one or more source characteristics.

21. The system of claim 1, wherein generating the user display is based at least in part on an algebraic expression based at least in part on the one or more consumption parameters.

22. The system of claim 1, wherein generating the user display is based at least in part on an algebraic expression based at least in part on a list of transportation determinations.

23. The system of claim 22, wherein the list of transportation determinations comprises a ranked list of transportation routes from a selected source geographic tile to a selected consumption geographic tile.

24. The system of claim 23, wherein the ranked list of transportation routes comprises a ranked list in terms of one of the following: a transportation cost, a transportation greenhouse gas emission, or a transportation time.

25. A method comprising:
receiving, using an interface, a user request;
determining, using a processor, a set of source geographic tiles based at least in part on the user request, wherein one or more source characteristics are associated with a source geographic tile of the set of source geographic tiles;
determining a list of consumption geographic tiles, wherein one or more consumption parameters are associated with a consumption geographic tile of the list of consumption geographic tiles;
generating a user display based at least in part on the one or more source characteristics and on the one or more consumption parameters; and
providing the user display to a user associated with the user request.

26. A computer program product embodied in a non-transitory computer readable medium and comprising computer instructions for:
receiving, using an interface, a user request;
determining, using a processor, a set of source geographic tiles based at least in part on the user request, wherein one or more source characteristics are associated with a source geographic tile of the set of source geographic tiles;
determining a list of consumption geographic tiles, wherein one or more consumption parameters are associated with a consumption geographic tile of the list of consumption geographic tiles;
generating a user display based at least in part on the one or more source characteristics and on the one or more consumption parameters; and
providing the user display to a user associated with the user request.
